(19) United States
(12) Patent Application Publication
(10) Pub. No.: US 2017/0267706 A1
(43) Pub. Date: Sep. 21, 2017

(54) METHOD FOR THE SYNTHESIS OF HETEROCYCLIC HYDROGEN PHOSPHINE OXIDE

(71) Applicant: STRAITMARK HOLDING AG, Zug (CH)

(72) Inventors: Frederic BRUYNEEL, Ophain-Bois-Seigneur-Isaac (BE); Patrick Pierre NOTTE, Wavre (BE)

(73) Assignee: STRAITMARK HOLDING AG, Zug (CH)

(21) Appl. No.: 15/505,175

(22) PCT Filed: Aug. 18, 2015
(86) PCT No.: PCT/EP2015/068972

§ 371 Date: Feb. 20, 2017

(30) Foreign Application Priority Data
Aug. 19, 2014 (EP) 14181365.9

(51) Int. Cl. C07F 9/6584; C08K 5/527; C08K 5/5399; C07F 9/6574; C09K 21/12

(52) U.S. Cl. CPC C07F 9/65844; C07F 9/65742; C07F 9/65744; C09K 21/12; C08K 5/5399; C08K 5/527

(57) ABSTRACT

A method for the synthesis of a heterocyclic hydrogen phosphine oxide, having the general formula:

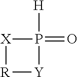

wherein:
R is a aliphatic or aromatic divalent group optionally including one or more heteroatoms and optionally having one or more substituents and
X and Y are independently selected from —O—, —C(O)O— and —NR′—
wherein R′ is a monovalent group optionally having one or more heteroatoms including the steps of:
a) forming a reaction mixture by mixing a compound having the general formula HX—R—YH and tetraphosphorus hexaoxide; and
b) recovering the resulting compound comprising the heterocyclic hydrogen phosphine oxide.

### FIELD OF THE INVENTION

The present invention is related to a method for the synthesis of heterocyclic hydrogen phosphine oxide.

### STATE OF THE ART

The methods hitherto known for the preparation of heteroatom substituted phosphine oxides and in particular phosphites including cyclic phosphites in general can be subdivided in:
the transesterification of aryl- and/alkylphosphites with polyols,
the reaction of a phosphorus trihalide and polyols and
the reaction of polyols with phosphonic acid,
the reaction of polyols with elemental phosphorus in the presence of oxygen.

U.S. Pat. No. 4,092,377 patent discloses the process of preparing a polyalkylene glycol alkyl or haloalkyl polyphosphonate characterized by an acid number below 15 mg KOH/g and a hydroxyl number below 150 mg KOH/g, said process comprising heating a polyalkylene glycol alkyl or haloalkyl polyphosphite at a temperature in the range of from 160° C. to 230° C. in the presence of an Arbusov rearrangement catalyst and preferably in the presence of an alkyl- or aralkyl halide. The polyalkylene glycol alkyl or haloalkyl polyphosphite are obtained from transesterification reaction of a tertiary phosphite with a polyalkylene glycol. The polyalkylene glycol alkyl or haloalkyl polyphosphonate is used as flame-retardant mainly in polyurethane foams through copolymerization.

U.S. Pat. No. 3,441,633 patent discloses new tetraphosphites obtained from reaction of heterocyclic phosphites and tertiary alkyl, aryl or haloaryl phosphites, said heterocyclic phosphites obtained from reaction of a polyalkylene glycol with a tertiary phosphite. The tetraphosphites are used as stabilizer and fire- and flame retardants in a wide range of polymer systems.

U.S. Pat. No. 3,352,947 patent discloses new polyol alkyl hydrogen phosphites and their method of manufacture, wherein preferably one mole of polyhydric alcohol and two moles of dialkyl hydrogen phosphite are mixed together and heated to a temperature of about 100° C. and higher. The non-cyclic property of the polyol phosphites permits a higher phosphorus content in the polyol phosphite product. The polyol alkyl hydrogen phosphites are useful as flame retardant and self-extinguishing components in resins such as epoxy or polyurethane resins.

U.S. Pat. No. 3,293,327 patent discloses specific bicyclic phosphites and phosphates and a method for preparing them wherein triaryl phosphite or trihaloaryl phosphite is reacted with trimethylolalkane or pentaerythritol. The compounds are useful as heat stabilizer in vinyl halide resins and as antioxidants in natural and synthetic rubbers, fats and oils.

U.S. Pat. No. 3,271,329 patent discloses a method for the synthesis of polymers derived from dialkyl or diaryl hydrogen phosphites and certain glycols, wherein the hydroxyl groups are separated by more than three carbon atoms, or dihydroxy aromatic compounds. For glycols wherein the hydroxyl groups are separated by three carbon atoms or less, cyclic organophosphorus compounds instead of organophosphorus polymers are generally formed. Similarly, for dihydroxy aromatic compounds it desirable that the hydroxyl groups are in para or meta positions in the compound. For the hydroxyl groups in ortho position, cyclic organophosphorus compounds instead of organophosphorus polymers are generally formed. The method comprises a transesterification at a temperature within the range of 0° C. to 350° C. for a reaction period within the range of 1 to 16 hours whereby substantially equimolar proportions of phosphite and dihydroxy compound are reacted.

U.S. Pat. No. 3,152,164 patent discloses an improved process for the preparation of a cyclic hydrogen phosphite which comprises reacting a material selected from the group consisting of a dialkyl hydrogen phosphite, a diaryl hydrogen phosphite and an alkyl aryl hydrogen phosphite with a material selected from the group consisting of 1,2-glycol, 1,3-glycol, vicinal glycol, and α,ω-glycol at a temperature of from 10° C. to 180° C. and a pressure of from 1 mm Hg to 5 atmospheres, in the absence of a catalyst, and removing the alcohol formed during the reaction. In the process it is preferred to utilize mole ratios of 0.7 to 1.3 moles of glycol per mole of phosphorus material.

U.S. Pat. No. 3,641,225 patent discloses a process for the preparation of a cyclic phosphorohalidite comprising reacting a glycol with a phosphorus trihalide in the presence of a solvent selected from the group consisting of dioxane and tetrahydrofuran. Hydrogen chloride, formed as a by-product, as well as the solvent afterwards are removed, under reduced pressure, from the phosphorohalidite reaction product. The phosphorohalidite then is further reacted with an epoxide to form a halogenated heterocyclic phosphite which subsequently is reacted with sulphur to form a halogenated heterocyclic phosphorothionate. The halogenated heterocyclic phosphorothionates find utility as additive-type flame retardants in plastics and resins such as polyurethane foams.

U.S. Pat. No. 3,270,092 patent discloses new cyclic phosphonites and a method for preparing them wherein an alkyl- or aryl-phosphonous dihalide is reacted with a saturated aliphatic dihydric alcohol at a temperature of from −50° C. to 100° C. in the presence of an acid acceptor substance (hydrogen halide scavenger) such as for example a tertiary amine.

U.S. Pat. No. 3,132,169 discloses particular halogenated phosphorus esters and a method for preparing them by reacting bromine and 2-chloro-1,3,2-dioxaphospholane or 2-chloro-1,3,2-dioxaphosphorinane which are obtained from the reaction of phosphorus trichloride and a 1,2-diol or 1,3-diol respectively.

U.S. Pat. No. 2,916,508 patent discloses a method for the preparation of 2,2-dimethyl-1,3-propanediol cyclic hydrogen phosphite which comprises reacting in substantially equal molar proportions 2,2-dimethyl-1,3-propanediol, phosphorus trichloride and a saturated aliphatic alcohol containing 1 to 8 carbon atoms at a temperature in the range of from 0° C. to 100° C.

A general method for the synthesis of cyclic H-phosphonates starting from phosphorus trichloride and aliphatic glycols is described in H. J. Lucas, F. W. Mitchell, C. N. Scully, J. Am. Chem. Soc., 1950, 72, 5491. 4-Methyl-2-oxo-2-hydroxy-1,3,2-dioxaphospholane was obtained in two stages. In a first stage 1,2-propanediol reacts with phosphorus trichloride, yielding 2-chloro-4-methyl-1,3,2-dioxaphospholane which in a second stage is hydrolyzed to give 4-methyl-2-oxo-2-hydroxy-1,3,2-dioxaphospholane. The hydrolysis was carried out in a dichloromethane solution with a mixture of water and 1,4-dioxane in the presence of triethylamine. 2-oxo-2-hydroxy-1,3,2-dioxaphosphorinane or 4-methyl-2-oxo-2-hydroxy-1,3,2-phosphorinane were obtained following the same procedure starting from 1,3-propanediol or 1,3-butanediol.

The one-pot synthesis of phosphonic acid diesters by the direct reaction of phosphonic acid with various hydroxy compounds in the presence of dicyclohexylcarbodiimide in tetrahydrofuran is described by A. Munor, C. Hubert and J-L. Luche in J. Org. Chem. 1996, 61, 6015-6017. A solution of dry phosphonic acid in dry tetrahydrofuran is rapidly added to a mixture of the hydroxyl compound and carbodiimide in dry tetrahydrofuran. Using ³¹P NMR the authors show the immediate replacement of the phosphonic acid signal by a peak corresponding to phosphorous anhydride. It is difficult to imagine for the one skilled in the phosphorus chemistry that dehydration from phosphonic acid to P₄O₆ would occur in one single step; instead it is expected that partially dehydrated forms of phosphonic acid containing P—O—P containing moieties would be formed gradually. In the presence of hydroxyl groups these P—O—P containing moieties will react with the hydroxyl compounds. Only in the absence of hydroxyl containing compounds the reaction of phosphonic acid with carbodiimide would be expected to lead to P₄O₆. Yet the presence of the hydroxyl compounds is expected to prevent said potential P₄O₆ formation since the P—O—P containing moieties, once formed, will react with the hydroxyl compounds and not further dehydrate to P₄O₆. Phosphonic acid will evolve to phosphonic acid diesters by further formation of P—O—P containing moieties and reaction of said P—O—P containing moieties with hydroxyl group containing compounds.

The publication does not disclose the synthesis of phosphonic acid diesters starting from the P₄O₆ and hydroxyl compounds; the publication even does not give the slightest indication or incitement for using said starting reagents or about how to use them in an appropriate way.

U.S. Pat. No. 2,661,364 patent discloses a process for the preparation of alkylphosphites wherein white phosphorus and oxygen are reacted at a temperature comprised between 40° C. and 75° C. with a primary alkanol.

DD 100475 discloses a method for the production of (cyclo)aliphatic or aromatic mono- and diamides of phosphonic acid through reaction of primary or secondary (cyclo)aliphatic or aromatic amines with phosphor(III)-oxide. DD 100475 does not deal with heterocyclic hydrogen phosphine oxides as only mono-amines are claimed.

### Aims of the Invention

The present invention aims to provide a method for the synthesis of heteroatom substituted phosphine oxides and specifically of heterocyclic hydrogen phosphine oxides that does not present the drawbacks of the methods of the state of the art.

It is, in particular an aim of the present invention to provide a process capable of selectively delivering superior compound grades at high purity and high yield.

Another aim of the present invention is to synthesize the heterocyclic hydrogen phosphine oxides in a shortened, energy efficient and economically attractive manner.

Advantageously the method of this invention is environmentally-friendly, and safe.

### SUMMARY OF THE INVENTION

The present invention discloses a method for the synthesis of a heterocyclic hydrogen phosphine oxide, having the general formula:

wherein:

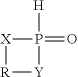

R is a aliphatic or aromatic divalent group optionally comprising one or more heteroatoms and optionally comprising one or more substituents and
X and Y are independently selected from —O—, —C(O)O— and —NR′— wherein R′ is a monovalent group optionally comprising one or more heteroatoms

comprising the steps of:
a) forming a reaction mixture by mixing a compound having the general formula HX—R—YH and tetraphosphorus hexaoxide;
b) recovering the resulting compound comprising the heterocyclic hydrogen phosphine oxide.
   wherein:
an aliphatic or aromatic divalent group is defined as a hydrocarbon derived from removal of 2 hydrogen atoms from different carbon atoms of an alkane, alkene or alkyne or from removal of 2 hydrogens from carbon atoms of the aromatic ring(s) of an arene or a biarene; and
a monovalent group is defined as a hydrocarbon derived from removal of 1 hydrogen atom from an alkane, alkene or alkyne.

Preferred embodiments of the present invention disclose one or more of the following features:
the molar ratio of the compound with general formula HX—R—YH to tetraphosphorus hexaoxide is comprised between 5.0 and 2.0, preferably between 4.5 and 2.5 and more preferably between 4.0 and 3.0;
the compound with general formula HX—R—YH is characterized in that:
   X and Y are independently selected from —O—, —C(O)O— and —NR′—, wherein R′ is an alkyl, alkenyl or alkynyl radical, having 1 to 10 carbon atoms, optionally comprising one or more heteroatoms selected from the group consisting of oxygen, nitrogen, sulphur and phosphorus, and optionally comprising one or more substituents selected from the group consisting of alkoxy, alkyl alkanoate, alkyl carboxylate, nitrile, carbamoyl, sulfanyl and halogen;
   R is an alkylene, alkenylene or alkynylene radical having 2 to 20 carbon atoms and optionally comprising one or more heteroatoms selected from the group consisting of oxygen, nitrogen, phosphorus and sulfur and optionally comprising one or more substituents selected from the group consisting of aryl, alkaryl, alkenaryl, alkynaryl, alkoxy, alkyl alkanoate, alkyl carboxylate, nitrile, carbamoyl, sulfanyl and halogen or
   R is an aryl or biaryl radical, optionally comprising one or more heteroatoms selected from the group consisting of oxygen, nitrogen, phosphorus and sulfur and optionally comprising one or more substituents R′;
   X and Y are separated by 10 or less carbon-carbon and/or carbon-heteroatom single and/or double and/or triple bonds; whereby for cyclic aliphatic or aromatic compounds the lowest number of bonds is meant;
step a) comprises a solvent selected from the group consisting of tetrahydrofuran, 2-methyltetrahydrofuran, acetonitrile, dichloromethane and mixtures thereof;
step a) comprises a dehydrating agent selected from the group consisting of organic dehydrating agents preferably an acid anhydride selected from the group consisting of acetic anhydride, trifluoroacetic anhydride and mixtures thereof; an orthoester such as trimethyl orthoformate or a carbodiimide such as N,N′-dicyclohexylcarbodiimide;
step a) comprises a dehydrating agent selected from the group consisting of inorganic dehydrating agents, preferably zeolite with a pore size of 4 Å;
the dehydrating agent is added from the beginning of the reaction when said dehydrating agent does not react with the reactants;
tetraphosphorus hexaoxide is added over a period of time comprised between 5 minutes and 2 hours to the compound with general formula HX—R—YH, comprising the solvent, standing at a temperature comprised between 10° C. and 80° C.;
step a), after the completion of the tetraphosphorus hexaoxide addition, is maintained at a temperature comprised between 10° C. and 80° C. for a period of time comprised between 10 minutes and 20 hours;
the resulting compound comprising the heterocyclic hydrogen phosphine oxide is recovered in step b) through distilling off the solvent;
the resulting compound comprising the heterocyclic hydrogen phosphine oxide is recovered in step b) through crystallization;
the compound with general formula HX—R—YH is selected from the group consisting of ethylene glycol; 1,2-propanediol; 2,2-dimethyl-1,3-propanediol; 2-phenyl-1,2-propanediol; 3-allyloxy-1,2-propanediol; 3-chloro-1,2-propanediol; 1,3-butanediol; 2,3-butanediol; 2,3-dimethyl-2,3-butanediol; 1,1,2,2-tetraphenyl-1,2-ethanediol; triethylene glycol; 1,10-decanediol; 2,2′-biphenol, and 1,1′-bis-2-naphtol; 2-hydroxybenzoic acid; pinanediol and (S)-(−)-α,α-diphenyl-2-pyrrolidinemethanol;
the weight ratio of solvent to the total amount of reactants in step a) is comprised between 0.5 and 5
heterocyclic hydrogen phosphine oxide, obtained by the method of the present invention is used as fire- and flame-retardant, heat stabilizer and antioxidant;
heterocyclic hydrogen phosphine oxide, obtained by the method of the present invention, is used as functional building block for the synthesis of chemicals or polymers comprising phosphorus in an oxidation state (+III);
heterocyclic hydrogen phosphine oxide, obtained by the method of the present invention, is used as monomer for the synthesis of homo- and copolymers;
heterocyclic hydrogen phosphine oxide, obtained by the method of the present invention, is used as ligands for stereo-selective catalysis using transition metals;
heterocyclic hydrogen phosphine oxide, obtained by the method of the present invention, is used for the synthesis of functionalized alkylphosphonates or esters thereof.

### DETAILED DESCRIPTION OF THE INVENTION

The present invention provides an improved method that is safe, economic and environmental friendly, for the synthesis of heteroatom substituted phosphine oxides and in particular of heterocyclic hydrogen phosphine oxides.

The present invention provides, in particular, a process wherein use is made of no toxic or less toxic solvents, without the need of organic or inorganic bases and wherein no toxic by-products are formed, briefly worded a process attractive over prior art processes.

The method includes the steps of:

reacting tetraphosphorus hexaoxide and a compound having the general formula HX—R—YH, in the presence of a solvent, tetraphosphorus hexaoxide being gradually added to a compound having the general formula HX—R—YH, while controlling the temperature at a value of 80° C. or less, preferably at a value comprised between about 20° C. and about 50° C. to form a solution comprising a heterocyclic hydrogen phosphine oxide with a yield of 50% or more, preferably at least 70% and more preferably at least 90%;

further processing said solution through distilling off the solvent or cooling down said solution inducing the crystallization, and recovering the heterocyclic hydrogen phosphine.

The tetraphosphorus hexaoxide used within the scope of the present invention may be represented by a substantially pure compound containing at least 85%, preferably more than 90%, more preferably at least 95% and in one particular embodiment at least 97% of P₄O₆. While tetraphosphorus hexaoxide, suitable for use within the context of this invention, may be manufactured by any known technology, it is preferably prepared in accordance with the method described in WO 2009/068636 and/or WO 2010/055056 under the section entitled “Process for the manufacture of P₄O₆ with improved yield”. In detail, oxygen, or a mixture of oxygen and inert gas, and gaseous or liquid phosphorus are reacted in essentially stoichiometric amounts in a reaction unit at a temperature in the range from about 1600 to about 2000 K, by removing the heat created by the exothermic reaction of phosphorus and oxygen, while maintaining a preferred residence time of from about 0.5 to about 60 seconds followed by quenching the reaction product at a temperature below 700 K and refining the crude reaction product by distillation. The tetraphosphorus hexaoxide so prepared is a pure product containing usually at least 97% of the oxide.

The so produced P₄O₆ is generally represented by a liquid material of high purity containing in particular low levels of elementary phosphorus, P₄, preferably below 1000 ppm, expressed in relation to the P₄O₆ being 100%. The preferred residence time is from about 5 to about 30 seconds, more preferably from about 8 to about 30 seconds. The reaction product can, in one preferred embodiment, be quenched to a temperature below 350 K.

It is presumed that the P₄O₆ participating in a reaction at a temperature of from 24° C. (melting t°) to 200° C. is necessarily liquid or gaseous although solid species can, academically speaking, be used in the preparation of the reaction medium.

For reasons of convenience and operational expertise, the tetraphosphorus hexaoxide, represented by P₄O₆, is of high purity containing very low levels of impurities, in particular elemental phosphorus, P₄, at a level below 1000 ppm, usually below 500 ppm and preferably not more than 200 ppm, expressed in relation to the P₄O₆ being 100%.

The compound with general formula HX—R—YH is characterized in that:
X and Y are independently selected from —O—, —C(O)O— and —NR′—, wherein R′ is an alkyl, alkenyl or alkynyl radical, having 1 to 10 carbon atoms, optionally comprising one or more heteroatoms selected from the group consisting of oxygen, nitrogen, sulphur and phosphorus, and optionally comprising one or more substituents selected from the group consisting of alkoxy, alkyl alkanoate, alkyl carboxylate, nitrile, carbamoyl, sulfanyl and halogen;
R is an alkylene, alkenylene or alkynylene radical having 2 to 20 carbon atoms and optionally comprising one or more heteroatoms selected from the group consisting of oxygen, nitrogen, phosphorus and sulfur and optionally comprising one or more substituents selected from the group consisting of aryl, alkaryl, alkenaryl, alkynaryl, alkoxy, alkyl alkanoate, alkyl carboxylate, nitrile, carbamoyl, sulfanyl and halogen or
R is an aryl or biaryl radical, optionally comprising one or more heteroatoms selected from the group consisting of oxygen, nitrogen, phosphorus and sulfur and optionally comprising one or more substituents R′;
X and Y are separated by 10 or less carbon-carbon and/or carbon-heteroatom single and/or double and/or triple bonds; when cyclic aliphatic or aromatic compounds are considered it is obvious that with said separation the lowest number of bonds is meant.

The compound with general formula HX—R—YH preferably is selected from the group consisting of ethylene glycol; 1,2-propanediol; 2,2-dimethyl-1,3-propanediol; 2-phenyl-1,2-propanediol; 3-allyloxy-1,2-propanediol; 3-chloro-1,2-propanediol; 1,3-butanediol; 2,3-butanediol; 2,3-dimethyl-2,3-butanediol; 1,1,2,2-tetraphenyl-1,2-ethanediol; triethylene glycol; 1,10-decanediol; 2,2′-biphenol; 1,1′-bis-2-naphtol; 2-hydroxybenzoic acid; pinanediol and (S)-(−)-α,α-diphenyl-2-pyrrolidinemethanol.

In the method of the present invention the molar ratio of the compound with general formula HX—R—YH to tetraphosphorus hexaoxide is comprised between 5.0 and 2.0, preferably between 4.5 and 2.5 and more preferably between 4.0 and 3.0

The compound with general formula HX—R—YH is dissolved in a solvent where the weight ratio of solvent to the total weight of reactants is comprised between 0.5 and 5.0.

Typical examples of suitable solvents, optionally used in the method according to the present invention, are anisole, fluorobenzene, chlorobenzene, tetrachloroethane, tetrachloroethylene, dichloroethane, dichloromethane, diglyme, glyme, diphenyloxide, polyalkylene glycol derivatives with capped OH groups, hexane, heptane, cyclohexane, dibutyl ether, diethyl ether, diisopropyl ether, dipentylether, butylmethylether, tetrahydrofuran, 2-methyltetrahydrofuran, dioxane, tetrahydropyran; cyclopentylmethylether, sulfolane, toluene, benzene, xylene, ethylacetate, acetonitrile, benzonitrile, polymethylphenyl siloxane or mixtures thereof and non-reactive ionic liquids like 1-n-butyl-imidazolium trifluoromethanesulfonate, and 1-ethyl-3-methyl-imidazolium bis(trifluoromethyl sulfonyl)imide or a mixture thereof.

The solvent preferably is selected from the group consisting of tetrahydrofuran, 2-methyltetrahydrofuran, acetonitrile, dichloromethane and mixtures thereof and is preferably substantially anhydrous. In general the substantial anhydrous solvent optionally is obtained through the addition of molecular sieve with a pore size of preferably 4 Angström.

Tetraphosphorus hexaoxide is gradually added to the mixture comprising the compound with general formula HX—R—YH and the solvent, preferably the anhydrous solvent, in order to control the strong exotherm and to control the temperature of the reaction at a value comprised between about 10° C. and 80° C. and preferable between 20° C. and 50° C.

Tetraphosphorus hexaoxide is added over a period of time comprised between about 5 minutes and about 2 hours, dependent on the capabilities of the reactor's heat exchanging means and the respective quantities of reactants, among others.

After the completion of the tetraphosphorus hexaoxide addition, a dehydrating agent preferably is added to the reaction mixture which is further stirred and reacted for an additional period of time comprised between about 10 minutes and about 20 hours at a temperature comprised between about 10° C. and about 80° C. and preferably between about 20° C. and about 50° C.

The dehydrating agents preferably used in the method of the present invention are organic dehydrating agents such as an acid anhydride selected from the group consisting of acetic anhydride, acetic formic anhydride, butyric anhydride, 3-chlorophthalic anhydride, 4-chlorophthalic anhydride, disulfuric acid, dodecenyl succinic anhydride, ethylenetetracarboxylic dianhydride, maleic anhydride, malonic anhydride, mellitic anhydride, methanesulfonic anhydride, phthalic anhydride, propionic anhydride, succinic anhydride, trifluoroacetic anhydride, trifluoromethanesulfonic anhydride and mixtures thereof; an orthoester such as for example trimethyl orthoformate or a carbodiimide such as for example N,N′-dicyclohexylcarbodiimide or inorganic dehydrating agents selected from the group consisting of calcium sulphate, sodium sulphate, magnesium sulphate, calcium chloride, aluminium oxide, all in their anhydrous form, and aluminosilicate minerals.

Within the context of the method of the present invention acetic anhydride and trifluoroacetic anhydride are preferred organic dehydrating agents.

The dehydrating agent preferably is added in such an amount that the ratio of equivalents of dehydrating agent to moles of tetraphosphorus hexaoxide is about 2.0.

Dehydrating agents which are non-reactive with respect to the initial reactants i.e. HX—R—YH compound and P₄O₆, can be added at the beginning of the reaction i.e. along with the HX—R—YH compound and the solvent. In general, this is the case for inorganic dehydration agents.

In a preferred embodiment of the present invention, molecular sieve with a pore size of 4 Å is used as dehydrating agent and is added at the beginning of the process. In general, 4 Å molecular sieve is added in an amount of about 50% weight of the HX—R—YH compound.

After completing step a) the solution comprising the heterocyclic hydrogen phosphine oxide is cooled down in step b) to room temperature or below, whereupon crystallization of the heterocyclic hydrogen phosphine oxide may be initiated. The precipitate is then separated from the filtrate using conventional filtration techniques well known in the art.

The precipitate being isolated subsequently may be washed and optionally recrystallized using a solvent selected among these enumerated as suitable solvents for performing step a).

In another approach, after completion of step a), the solvent is distilled off in step b) whereupon the product, thus recovered, may be recrystallized using a solvent selected among these enumerated as suitable solvents for performing step a). The selection of the right solvent is dependent on the type of heterocyclic hydrogen phosphine oxide prepared in step a) and is common practice for those skilled in the art.

The heterocyclic hydrogen phosphine oxide obtained by the method of the present invention is characterized by the general formula:

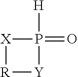

wherein X, Y, R′ and R have the same meaning as for the HX—R—YH compound such as disclosed in [0030].

Typical and preferred examples of heterocyclic hydrogen phosphine oxide prepared using the method according to the present invention are 2-oxo-4,4,5,5-tetramethyl-1,3,2-dioxaphospholane; 2,4-dioxo-5,6-benzo-1,3,2-dioxaphosphorinane; 2-oxo-4,4,5,5-tetraphenyl-1,3,2-dioxaphospholane; 2-hydro-5,5-dimethyl-2-oxo-1,3,2-dioxaphosphorinane; 2-hydro-4,5-dimethyl-2-oxo-1,3,2-dioxaphospholane; 2-hydro-2-oxo-1,3,2-dioxaphosphorinane; 2-2,2′-biphenyl phosphite; 2-2,2′-binaphtyl phosphite; 2-oxo-4-allylyoxymethyl-1,3,2-dioxaphospholane; 2-oxo-4-methyl-4-phenyl-1,3,2-dioxaphospholane; 2-oxo-4-methyl-1,3,2-dioxaphospholane; 2-oxo-4-chloromethyl-1,3,2-dioxaphospholane; (2R,3aR,4R,6R,7aS)-3a,5,5-trimethylhexahydro-4,6-methanobenzo[d][1,3,2]dioxaphosphole 2-oxide-rel-; (3S)-3,3-diphenylhexahydropyrrolo[1,2-c][1,2,3]oxazaphospholidine.

### EXAMPLES

The following examples illustrate the invention; they are merely meant to exemplify the present invention but are not destined to limit or otherwise define the scope of the present invention.

The glassware used in the examples as described below, was dried in an oven for several hours (60° C.) prior being used in the reactions. Molecular sieves was activated for 2 to 4 hours at 220° C. and kept afterward at room temperature over P₂O₅ in a desiccator.

A magnetic stirring bar was used for the small scale reaction and a mechanical stirrer was used for the large scale reaction. The solvents and reagents were of analytical grade and used as received. In particular cases, anhydrous solvents were used as specified in the respective examples.

For product characterization, NMR spectra were recorded on a Bruker Avance 400 spectrometer using CDCl₃ or CDCl₃/TFA (3/1) as solvent. TMS and H₃PO₄ 85% were used as reference for ¹H, ¹³C and ³¹P nuclei. For known products, the JP-H coupling constant was used to unambiguously identify the H-phosphonate.

### Example 1

In a dried vial containing a magnetic stirring bar were successively added 5.9 g of pinacol 97% (50 mmole), and 15 ml of anhydrous tetrahydrofuran under N₂. The vial was closed and to the stirred solution was added 2.75 g of P₄O₆ (12.5 mmole) slowly over 30 minutes at room temperature to avoid a strong exotherm. The reaction mixture was stirred overnight at room temperature under sonication. The volatiles were removed and to the residues was added 3 ml of ethyl acetate. This solution was kept closed at 4° C. overnight. The desired product crystallized upon cooling. The yield of 2-oxo-4,4,5,5-tetramethyl-1,3,2-dioxaphospholane was 79% as determined in the crude by ³¹P NMR analysis (CDCl₃). The target compound was isolated in 65% isolated yield with a purity of 90% (10% of H₃PO₃ as impurity).

### Example 2

In a dried vial containing a magnetic stirring bar were successively added 1.18 g of pinacol 99% (10 mmole), and 1 ml of anhydrous tetrahydrofuran under N₂. The vial was closed and to the stirred solution was added 0.615 g of P₄O₆ (2.8 mmole) slowly over 10 minutes at room temperature to avoid a strong exotherm. Once the addition of P₄O₆ was done, 1.2 g trifluoroacetic anhydride (5.7 mmole) were added as dehydrating agent. The crude mixture was stirred 2 hours at room temperature under sonication. The yield of 2-oxo-4,4,5,5-tetramethyl-1,3,2-dioxaphospholane was 82.5% as determined in the crude by ³¹P NMR analysis (CDCl₃).

### Example 3

In a dried vial containing a magnetic stirring bar were successively added 1.18 g of pinacol 99% (10 mmole), 4 Å molecular sieves (50% wt/wt of diol) and 1 ml of 2-methyltetrahydrofuran. The vial was closed and to the stirred solution was added 0.66 g of P₄O₆ (3 mmole) slowly over 10 minutes at room temperature to avoid a strong exotherm. After stirring for 2 hours, the suspension was gently heated and transferred in a second vial. The desired product crystallized upon cooling. The yield of 2-oxo-4,4,5,5-tetramethyl-1,3,2-dioxaphospholane was 94% as determined in the crude by ³¹P NMR analysis (CDCl₃).

### Example 4

In a dried vial containing a magnetic stirring bar were successively added 6.9 g of salicylic acid (50 mmole) and 15 ml of anhydrous tetrahydrofuran under N₂. The vial was closed and to the stirred solution was added 2.75 g of P₄O₆ (12.5 mmole) slowly over 30 minutes at room temperature to avoid a strong exotherm. The crude was stirred overnight at room temperature under sonication. The yield of 2,4-dioxo-5,6-benzo-1,3,2-dioxaphosphorinane was 80% as determined in the crude by ³¹P NMR analysis (CDCl₃). The target compound was isolated after evaporation of the solvent and recrystallized from diethyl ether with an isolated yield of 70% and a purity of 85% (15% of H₃PO₃ as impurity).

### Example 5

In a dried vial containing a magnetic stirring bar were successively added 18.3 g of benzo-pinacol 97% (50 mmole), and 25 ml of anhydrous tetrahydrofuran under N₂. The vial was closed and to the stirred solution was added 2.75 g of P₄O₆ (12.5 mmole) slowly over 30 minutes at room temperature to avoid a strong exotherm. The crude was stirred overnight at room temperature under sonication. The yield of 2-oxo-4,4,5,5-tetraphenyl-1,3,2-dioxaphospholane was 40% as determined in the crude by ³¹P NMR analysis (CDCl₃).

### Example 6

In a dried vial containing a magnetic stirring bar were successively added 1.04 g of 2,2-dimethyl-1,3-propanediol (10 mmole), 4 Å molecular sieves (50% wt/wt of diol) and 1 ml of 2-methyltetrahydrofuran. The vial was closed and to the stirred solution was added 0.66 g of P₄O₆ (3 mmole) slowly over 10 minutes at room temperature to avoid a strong exotherm. After stirring for 2 hours, the suspension was gently heated and transferred in a second vial. The desired product solidified upon cooling. The yield of 2-hydro-5,5-dimethyl-2-oxo-1,3,2-dioxaphosphorinane was 67% as determined in the crude by ³¹P NMR analysis (CDCl₃).

### Example 7

In a dried flask of 250 ml containing a magnetic stirring bar were successively added 4 Å molecular sieves (50% wt/wt of diol), 50 ml of 2-methyltetrahydrofuran and 0.9 g of 2,3-butanediol (10 mmole). The magnetic agitation is used to obtain a perfectly dispersed solution before the addition of P₄O₆. Then, 0.66 g of P₄O₆ (3 mmole) is slowly added with a syringe at room temperature to avoid a strong exotherm. Subsequently the solution was stirred for 2 hours with a magnetic agitation around 400 rpm. The yield of 2-hydro-4,5-dimethyl-2-oxo-1,3,2-dioxaphospholane was 62% as determined in the crude by ³¹P NMR analysis (CDCl₃).

### Examples 8 to 12

In table 1 a series of examples, prepared according to the method of the present invention and using the equipment, the molar quantities and the reaction conditions of Example 7, are reported.

In this table:

Column 1: indicates the identification number of the example.
Column 2: indicates the type of diol put into reaction with P₄O₆.
Column 3: indicates the type of the cyclic phosphite.
Column 4: indicates the yield (%) of cyclic phosphite, determined in the crude by ³¹P NMR analysis (CDCl₃).

TABLE 1

| Ex | Diol | Cyclic phosphite | Yield |
|---|---|---|---|
| 8 | 1,3-butanediol | 2-hydro-2-oxo-1,3,2-dioxaphosphorinane | 43 |
| 9 | 2,2′-biphenol | 2-2,2′-biphenyl phosphite | 80 |
| 10 | 1,1′-bis-2-naphtol | 2-2,2′-binaphtyl phosphite | 80 |
| 11 | 3-allyloxy-1,2- | 2-oxo-4-allylyoxymethyl-1,3,2- | 46 |
| | propanediol | dioxaphospholane | |
| 12 | 2-phenyl-1,2- | 2-oxo-4-methyl-4-phenyl-1,3,2- | 40 |
| | propanediol | dioxaphospholane | |

### Example 13

In a dried flask of 250 ml containing a magnetic stirring bar were successively added 4 Å molecular sieves (50% wt/wt of diol), 25 ml of 2-methyltetrahydrofuran and 1.5 g of triethylene glycol (10 mmole). The solution is heated at 50° C. and the magnetic agitation is used to stir the suspension before the addition of P₄O₆. Then, 0.66 g of P₄O₆ (3 mmole) is slowly added with a syringe at 50° C. After stirring for 2 hours with a magnetic agitation around 400 rpm, the solution was tested by ³¹P NMR analysis (CDCl₃) indicating a yield of 33% of cyclic phosphite.

### Example 14

In a dried vial containing a magnetic stirring bar were successively added 1.86 g of 2,2′-biphenol (10 mmole), 4 Å molecular sieves (50% wt/wt of diol) and 5 ml of acetonitrile. The vial was closed and to the stirred suspension was added 0.66 g of P₄O₆ (3 mmole) slowly over 10 minutes at room temperature to avoid a strong exotherm. After stirring for 2 hours the solution was transferred in a second vial. The solvent was evaporated to give yellow oil. The yield of 2-2,2′-biphenyl phosphite was 75% as determined in the crude by ³¹P NMR analysis (CDCl₃).

### Example 15

In a dried flask of 250 ml containing a magnetic stirring bar were successively added 1.1 g of 3-chloro-1,2-propanediol (10 mmole), 4 Å molecular sieves (50% wt/wt of diol) and 35 ml of 2-methyltetrahydrofuran. The magnetic agitation is used to obtain a perfectly dispersed solution before the addition of P₄O₆. Then, 0.55 g of P₄O₆ (2.5 mmole) was slowly added with a syringe at room temperature to avoid a strong exotherm. After stirring for 2 hours, the solution was transferred in a vial. 45% of cyclic phosphite, 31% of a mixture of CH₂ and CH mono-phosphites and 18% of H₃PO₃ were found in the crude by ³¹P NMR analysis (CDCl₃).

### Example 16

In a dried flask of 250 ml containing a magnetic stirring bar were successively added 4 Å molecular sieves (50% wt/wt of diol), 25 ml of 2-methyltetrahydrofuran and 0.76 g of 1,2-propanediol (10 mmole). The magnetic agitation is used to obtain a perfectly dispersed solution before the addition of P₄O₆. Then, 0.66 g of P₄O₆ (3 mmole) is slowly added with a syringe at room temperature to avoid a strong exotherm. Subsequently the reaction mixture was stirred for 2 hours with a magnetic agitation around 400 rpm. The yield of 2-oxo-4-methyl-1,3,2-dioxaphospholane was 46% as determined in the crude by ³¹P NMR analysis (CDCl₃).

### Example 17

In a dried vial containing a magnetic stirring bar were successively added 0.86 g of (−) pinanediol (5.05 mmole), 4 Å molecular sieves (50% wt/wt of diol) and 5 ml of 2-methyltetrahydrofuran. The vial was closed and to the stirred solution was added 0.33 g of P₄O₆ (1.5 mmole) slowly over 10 minutes at room temperature to avoid a strong exotherm. After stirring for 2 hours, the suspension was gently stirred over poly-vinylpyridine (0.5 g). The filtrate was collected and evaporated. The yield of (2R,3aR,4R,6R,7aS)-3a, 5,5-trimethylhexahydro-4,6-methanobenzo[d][1,3,2]dioxaphosphole 2-oxide-rel- was 50% as determined in the crude by ³¹P NMR analysis (CDCl₃).

After filtration and evaporation, an oily product was isolated with a purity of 50% (20% of H₃PO₃ and 21% of half-hydrolysed phosphite).

### Example 18

In a dried vial containing a magnetic stirring bar were successively added 1 g of (S)-(−)-α,α-diphenyl-2-pyrrolidinemethanol (3.9 mmole), 4 Å molecular sieves (50% wt/wt of amino alcohol) and 10 ml of solvent (2-methyltetrahydrofuran/acetonitrile 1/1 v/v). The vial was closed and to the stirred solution was added 0.26 g of P₄O₆ (1.18 mmole) slowly over 10 minutes at room temperature to avoid a strong exotherm. After stirring for 2 hours, the suspension was evaporated. (3S)-3,3-diphenylhexahydropyrrolo[1,2-c][1,2,3]oxazaphospholidine was detected at 64% by ³¹P NMR analysis (CDCl₃)(contaminant is 12% H₃PO₃). The overall conversion is 76%.

### Example 19

In a dried vial containing a magnetic stirring bar were successively added 0.86 g of (−) pinanediol (5.05 mmole), 4 Å molecular sieves (50% wt/wt of diol) and 6 ml of 2-methyltetrahydrofuran. The vial was closed and to the stirred solution was added 0.33 g of P₄O₆ (1.5 mmole) slowly over 10 minutes at room temperature to avoid a strong exotherm. The solution was evaporated. The yield of (2R,3aR,4R,6R,7aS)-3a, 5,5-trimethylhexahydro-4,6-methanobenzo[d][1,3,2]dioxaphosphole 2-oxide-rel- was 57% as determined in the crude by ³¹P NMR analysis (CDCl₃). The overall conversion is 67% (13% of H₃PO₃).

### Example 20

In a dried vial containing a magnetic stirring bar were successively added 1.18 g of pinacol 99% (10 mmole) and 1 ml of anhydrous tetrahydrofuran under nitrogen. The vial was closed and to the stirred solution was added 0.615 g of P₄O₆ (2.8 mmole) slowly over 10 min at room temperature to avoid a strong exotherm. Once the addition of P₄O₆ was done, 0.612 g of acetic anhydride (6 mmole) was added as dehydrating agent. The crude mixture was stirred for 2 hours at room temperature under sonication. The yield of 2-oxo-4,4,5,5-tetramethyl-1,3,2-dioxaphospholane was 82.5% as determined in the crude by ³¹P NMR analysis (CDCl₃).

1. A method for the synthesis of a heterocyclic hydrogen phosphine oxide, having the general formula: 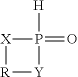
wherein:
R is a aliphatic or aromatic divalent group optionally comprising one or more heteroatoms and optionally comprising one or more substituents and
X and Y are independently selected from —O—, —C(O)O— and —NR′—
wherein R′ is a monovalent group optionally comprising one or more heteroatoms comprising the steps of:
a) forming a reaction mixture by mixing a compound having the general formula HX—R—YH and tetraphosphorus hexaoxide; and
b) recovering the resulting compound comprising the heterocyclic hydrogen phosphine oxide.

2. The method according to claim 1 wherein the molar ratio of the compound with general formula HX—R—YH to tetraphosphorus hexaoxide is comprised between 5.0 and 2.0.

3. The method according to claim 1, wherein the compound with general formula HX—R—YH is characterized in that:
X and Y are independently selected from —O—, —C(O)O— and —NR′—, wherein R′ is an alkyl, alkenyl or alkynyl radical, having 1 to 10 carbon atoms, optionally comprising one or more heteroatoms selected from the group consisting of oxygen, nitrogen, sulphur and phosphorus, and optionally comprising one or more substituents selected from the group consisting of alkoxy, alkyl alkanoate, alkyl carboxylate, nitrile, carbamoyl, sulfanyl and halogen;
R is an alkylene, alkenylene or alkynylene radical having 2 to 20 carbon atoms and optionally comprising one or more heteroatoms selected from the group consisting of oxygen, nitrogen, phosphorus and sulfur and optionally comprising one or more substituents selected from the group consisting of aryl, alkaryl, alkenaryl, alkynaryl, alkoxy, alkyl alkanoate, alkyl carboxylate, nitrile, carbamoyl, sulfanyl and halogen or
R is an aryl or biaryl radical, optionally comprising one or more heteroatoms selected from the group consisting of oxygen, nitrogen, phosphorus and sulfur and optionally comprising one or more substituents R′; and
X and Y are separated by 10 or less carbon-carbon and/or carbon-heteroatom single and/or double and/or triple bonds; whereby for cyclic aliphatic or aromatic compounds the lowest number of bonds is meant.

4. The method according to claim 1 wherein step a) comprises a solvent selected from the group consisting of tetrahydrofuran, 2-methyltetrahydrofuran, acetonitrile, dichloromethane and mixtures thereof.

5. The method according to claim 1 wherein step a) comprises a dehydrating agent selected from the group consisting of organic dehydrating agents preferably an acid anhydride selected from the group consisting of acetic anhydride, trifluoroacetic anhydride and mixtures thereof; an orthoester such as trimethyl orthoformate or a carbodiimide such as N,N′-dicyclohexylcarbodiimide.

6. The method according to claim 1 wherein step a) comprises a dehydrating agent selected from the group consisting of inorganic dehydrating agents.

7. The method according to claim 1 wherein the dehydrating agent does not react with the reactants and wherein said dehydrating agent is added from the beginning of the reaction.

8. The method according to claim 1 wherein tetraphosphorus hexaoxide is added over a period of time comprised between 5 minutes and 2 hours to the compound with general formula HX—R—YH, comprising the solvent, standing at a temperature comprised between 10° C. and 80° C.

9. The method according to claim 1 wherein step a), after the completion of the tetraphosphorus hexaoxide addition, is maintained at a temperature comprised between 10° C. and 80° C. for a period of time comprised between 10 minutes and 20 hours.

10. The method according to claim 1 wherein the resulting compound comprising the heterocyclic hydrogen phosphine oxide is recovered in step b) through distilling off the solvent.

11. The method according to claim 1 wherein the resulting compound comprising the heterocyclic hydrogen phosphine oxide is recovered in step b) through crystallization.

12. The method according to claim 1 wherein the compound with general formula HX—R—YH is selected from the group consisting of ethylene glycol; 1,2-propanediol; 2,2-dimethyl-1,3-propanediol; 2-phenyl-1,2-propanediol; 3-allyloxy-1,2-propanediol; 3-chloro-1,2-propanediol; 1,3-butanediol; 2,3-butanediol; 2,3-dimethyl-2,3-butanediol; 1,1,2,2-tetraphenyl-1,2-ethanediol; triethylene glycol; 1,10-decanediol; 2,2′-biphenol, and 1,1′-bis-2-naphtol; 2-hydroxybenzoic acid; pinanediol and (S)-(−)-α,α-diphenyl-2-pyrrolidinemethanol.

13. The method according to claim 1 wherein the weight ratio of solvent to the total amount of reactants in step a) is comprised between 0.5 and 5.

14. The method according to claim 1 wherein the molar ratio of the compound with general formula HX—R—YH to tetraphosphorus hexaoxide is comprised between 4.5 and 2.5.

15. The method according to claim 1 wherein the molar ratio of the compound with general formula HX—R—YH to tetraphosphorus hexaoxide is comprised between 4.0 and 3.0.

16. The method according to claim 1 wherein step a) comprises a dehydrating agent selected from the group consisting of zeolite with a pore size of 4 Å.
